(19) United States
(12) Patent Application Publication
(10) Pub. No.: US 2009/0140194 A1
(43) Pub. Date: Jun. 4, 2009

(54) VALVE DEVICE AND MULTI-LAYER SUBSTRATE

(76) Inventors: Takuya Kato, Miyagi-ken (JP); Takashi Kihara, Miyagi-ken (JP); Yasunari Kabasawa, Saitama-ken (JP)

Correspondence Address: BRINKS HOFER GILSON & LIONE, P.O. BOX 10395, CHICAGO, IL, 60610, US

(21) Appl. No.: 12/275,713

(22) Filed: Nov. 21, 2008

(30) Foreign Application Priority Data
Nov. 21, 2007 (JP) 2007-301781

(51) Int. Cl. F16K 1/00

(52) U.S. Cl. 251/318

(57) ABSTRACT

A valve device secured to a multi-layer substrate provided with an electrical wire and a flow path for a fluid includes a diaphragm disposed at a location allowing the flow path to be opened and closed, a stepping motor causing the flow path to be opened and closed by reciprocating the diaphragm, and a base holding the diaphragm while the diaphragm is interposed between the base and the multi-layer substrate when securing the valve device to the multi-layer substrate. In the valve device, a terminal electrically joined to the electrical wire is provided near a securing surface where the valve device is secured to the multi-layer substrate.

### CLAIM OF PRIORITY

This application claims benefit of the Japanese Patent Application No. 2007-301781 filed on Nov. 21, 2007, which is hereby incorporated by reference in its entirety.

### BACKGROUND OF THE INVENTION

1. Field of the Invention

The present invention relates to a valve device and a multi-layer substrate. More particularly, the present invention relates to a valve device that opens and closes a flow path formed in layers of a multi-layer substrate and to the multi-layer substrate to which the valve device is mounted.

2. Description of the Related Art

In the past, a valve device which is a valve mechanism applied to, for example, a fuel cell system, and which opens and closes a flow path for discharging fluid, such as water or gas, accumulated in a fuel cell has been proposed (refer to, for example, Japanese Unexamined Patent Application Publication Nos. 2005-195145 and 2007-16935). The valve device discussed in Japanese Unexamined Patent Application Publication No. 2005-195145 comprises a body (in which a primary flow path and a secondary flow path are formed), a pressure-receiving member having biasing force, and a throttle opening amount varying mechanism that is operated by an electromagnetic actuator. In the valve device, the primary flow path and the secondary flow path are formed in the body of the valve device.

On the other hand, in a small fuel cell system, such a related valve device is required to be applied to opening and closing a flow path formed in a layer of a substrate. If the flow path formed in the layer of the substrate can be opened and closed using the valve device, the primary and secondary flow paths are no longer required in the body of the valve device. Therefore, it is possible to reduce the size of the valve device and to reduce manufacturing costs of the valve device. However, in the above-described related art, a pressure-receiving member that has a resilient member and that can be expanded and contracted is disposed in the flow paths. Therefore, it is difficult to form the primary and secondary flow paths separately from the body of the valve device. Consequently, the valve device is not suitable for size reduction.

Unlike the case in which the flow paths are formed in the body of the valve device, when the flow path formed in the layer of the substrate is opened and closed using the valve device, it is necessary to electrically join a terminal of the valve device to an electrical wire formed at the substrate. Therefore, there is a demand for a valve device that allows an efficient joining operation.

### SUMMARY

Disclosed is a valve device secured to a multi-layer substrate provided with an electrical wire and a flow path for a fluid. The valve device comprises a valve disposed at a location allowing the flow path to be opened and closed, an actuator causing the flow path to be opened and closed by reciprocating the valve, and an enclosure holding the valve while the valve is interposed between the enclosure and the multi-layer substrate when securing the valve device to the multi-layer substrate. In the valve device, a terminal electrically joined to the electrical wire is provided near a securing surface where the valve device is secured to the multi-layer substrate.

### BRIEF DESCRIPTION OF THE DRAWINGS

FIG. 1 is an external perspective view of a valve device according to an embodiment of the present invention;

FIG. 2 is a top view of the valve device according to the embodiment;

FIG. 3 is a perspective view for illustrating an internal structure of the valve device according to the embodiment and an internal structure of a multi-layer substrate to which the valve device is secured;

FIG. 4 is a sectional view for illustrating the internal structure of the valve device according to the embodiment and the internal structure of the multi-layer substrate to which the valve device is secured;

FIG. 5 illustrates a state of a diaphragm when the valve device according to the embodiment is secured to the multi-layer substrate;

FIG. 6 illustrates the state of the diaphragm when the valve device according to the embodiment is secured to the multi-layer substrate;

FIG. 7 is a sectional view showing a state of structural parts in a vicinity of the diaphragm when the valve device according to the embodiment is secured to the multi-layer substrate; and

FIG. 8 is a sectional view showing a state in which flow paths formed in the multi-layer substrate are closed by the valve device according to the embodiment.

### DESCRIPTION OF THE PREFERRED EMBODIMENTS

A description of embodiments according to the present invention will hereunder be described in detail with reference to the attached drawings.

A valve device is applied to, for example, a fuel cell system, and is used when opening and closing a flow path for discharging a fluid, such as water or gas, accumulated in a fuel cell. However, the use of the valve device according to the present invention is not limited thereto, so that it may be applied to any device.

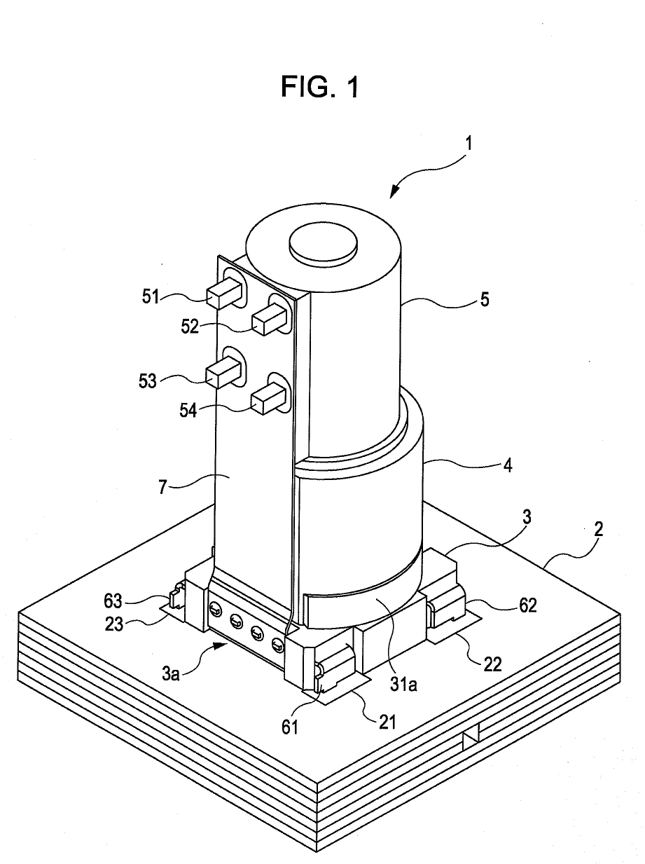

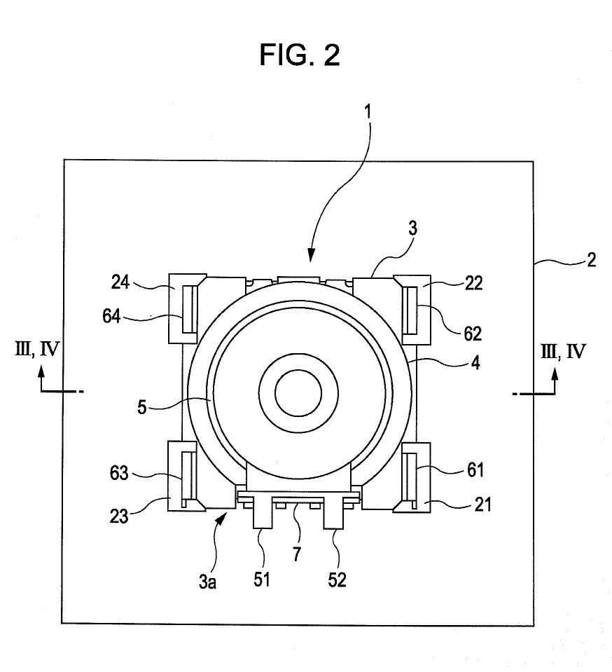

FIG. 1 is an external perspective view of a valve device 1 according to an embodiment of the present invention. FIG. 2 is a top view of the valve device 1 according to the embodiment. As shown in FIG. 1, the valve device 1 according to the embodiment has a substantially circular cylindrical shape. A lower end portion of the valve device 1 is secured to a multi-layer substrate 2. The multi-layer substrate 2 is formed by laminating a plurality of plates and joining them to each other. A recess or a groove pattern or a hole pattern is formed in the plurality of plates as appropriate. The multi-layer substrate 2 has an electrical wire formed on its surface, and a plurality of fluid flow paths formed in its layers. For example, it is possible to apply a plurality of the valve devices 1 to a fuel cell system to control a fluid flow amount of a fluid, for example, water (including water vapor), air, hydrogen gas, or fluid fuel, including alcohol or ether, which generates hydrogen when reformed. These fluids are required for a direct-fuel cell or a reformed fuel cell.

The valve device 1 generally includes a base 3, a housing 4, and a stepping motor (hereunder referred to as “motor”) 5. The base 3 is placed on the multi-layer substrate 2. The housing 4 is disposed at the upper side of the base 3. The stepping motor 5 is disposed at the upper side of the housing 4. The valve device 1, formed by connecting such structural parts, is secured to the multi-layer substrate 2. The base 3 constitutes an enclosure of the valve device 1, and the motor 5 constitutes an actuator.

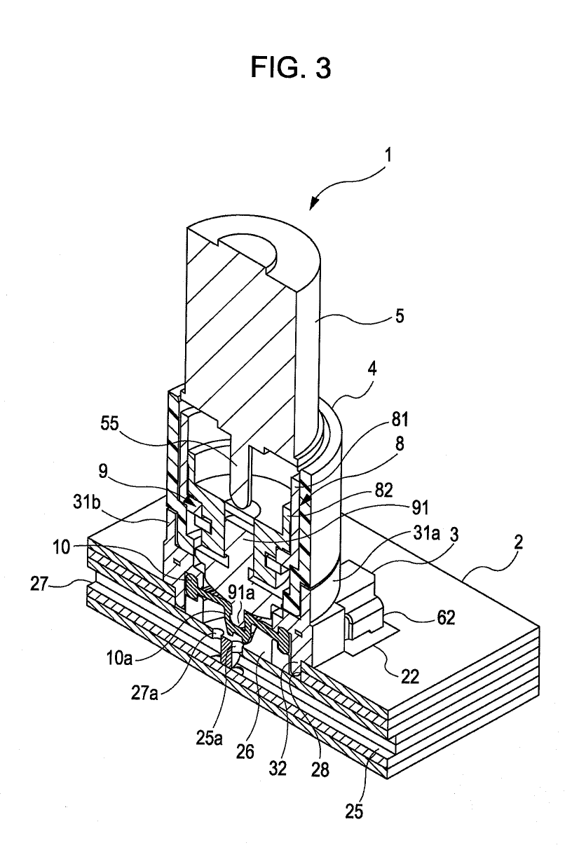

The base 3 is formed of an insulating resin material and has a generally flat box shape. The base 3 is hollow, and, for example, a diaphragm 10 (described later) is disposed in the base 3. The base 3 has a top outer peripheral surface that substantially matches the outer peripheral surface of the housing 4. The top surface of the base 3 is provided with a pair of supporting portions 31a and 31b, which support the housing 4 (the supporting portion 31b is not shown in FIG. 1; refer to FIG. 3). Input terminals 61 to 64 are insert-molded to the base 3 so that portions thereof are exposed from the four corners of the base 3 (the input terminal 64 is not shown in FIG. 1; refer to FIG. 2). Lower end portions of the input terminals 61 to 64 are disposed near a securing surface of the valve device 1 where it is secured to the multi-layer substrate 2. The input terminals 61 to 64 are routed to the interior of the base 3, with ends of the input terminals 61 to 64 being drawn out to one side (that is, to the left side in FIG. 1, and to a lower surface 3a in FIG. 2).

A protrusion 32 and two shafts (not shown) are formed at the lower side of the base 3. The protrusion 32 is fitted to a groove 28 of the multi-layer substrate 2 (described later). The two shafts are inserted into respective holes 30a and 30b of the multi-layer substrate 2. These shafts are used for positioning the base 3. In particular, the shafts have different thicknesses, to prevent the base 3 from being mounted in a wrong orientation.

The housing 4 is formed of an insulating resin material, and has a substantially circular cylindrical shape. The housing 4 accommodates in its interior a speed reduction mechanism 8 (described later) and a converting mechanism 9 (described later). As shown in FIG. 2, a peripheral surface of a portion of the housing 4 corresponding to the location of the surface 3a of the base 3 is cut away, and a flexible printed circuit (FPC) 7 (described later) can be disposed substantially vertically with respect to the multi-layer substrate 2. A lower end portion of the housing 4 is provided with a small-diameter portion that is inserted into the supporting portions 31a and 31b of the base 3. For example, the small-diameter portion inserted in the supporting portions 31a and 31b is adhered and secured in the supporting portions 31a and 31b, to secure the housing 4 to the base 3.

While a driving shaft of the motor 5 is accommodated in the housing 4, the motor 5 is mounted to the housing 4 so as to close an upper open portion of the housing 4. For example, adhering and securing the lower end surface of the motor 5 to the upper end surface of the housing 4 causes the motor 5 to be secured to the housing 4. Input terminals 51 to 54 are provided at portions of the motor 5 corresponding to the location of the surface 3a of the base 3. These input terminals 51 to 54 protrude in a certain direction from the outer peripheral surface of the motor 5. In addition, the flexible printed circuit (FPC) 7 is disposed so that these input terminals 51 to 54 are connected to ends of the input terminals 61 to 64 provided at the base 3. An external signal transmitted towards the motor 5 can be input through the flexible printed circuit 7.

The valve device 1 having such a structure is secured to a surface of the multi-layer substrate 2 by soldering. At this time, in the valve device 1 according to the embodiment, the lower end portions of the input terminals 61 to 64 provided at the base 3 are soldered to respective connection portions 21 to 24 (not shown in FIG. 1; refer to FIG. 2) provided at the multi-layer substrate 2. By soldering the input terminals 61 to 64 to the respective connection portions 21 to 24 (provided at the multi-layer substrate 2), the valve device 1 is secured to and electrically joined to the multi-layer substrate 2. When the connection portions 21 to 24 are connected to a wiring pattern (not shown) in the multi-layer substrate 2, and have the input terminals 61 to 64 joined thereto as mentioned above, an externally input motor drive signal can be input to the input terminals 51 to 54 through the input terminals 61 to 64.

Soldering the input terminals 61 to 64 to the connection portions 21 to 24 causes the valve device 1 according to the embodiment to be secured to the multi-layer substrate 2. Here, for example, when the valve device 1 is secured to the multi-layer substrate 2 with, for example, a mounting screw, an area for securing the valve device 1 onto the multi-layer substrate 2 with a mounting screw is required. This reduces mounting density at the multi-layer substrate 2. In contrast, when, the valve device 1 is secured to the multi-layer substrate 2 as in the embodiment, an area required when securing the valve device 1 to the multi-layer substrate 2 can be reduced in comparison with when the valve device 1 is secured with, for example, a mounting screw. That is, as shown in FIG. 2, the valve device 1 can be secured to the multi-layer substrate 2 using an area that is slightly larger than that of the base 3. Therefore, mounting density at the multi-layer substrate 2 can be increased.

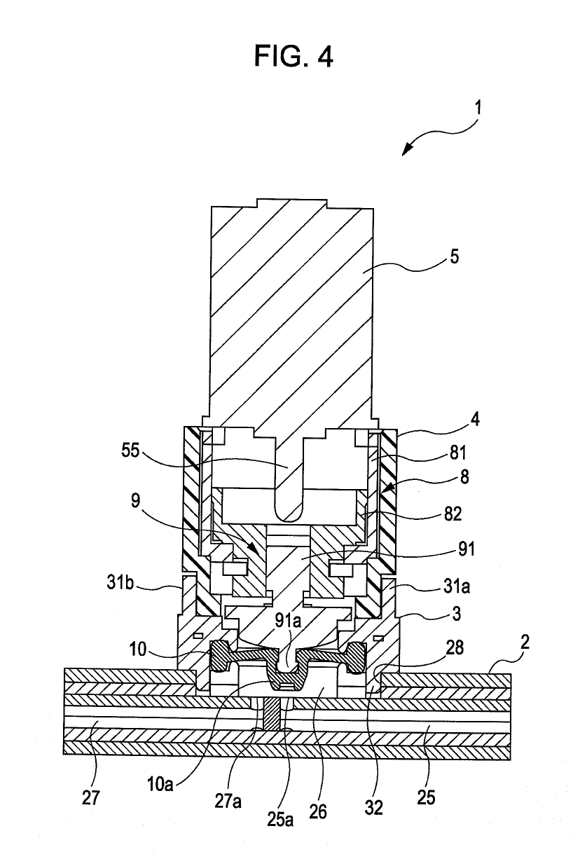

An internal structure of the valve device 1 according to the embodiment and an internal structure of the multi-layer substrate 2 to which the valve device 1 is secured will hereunder be described. FIGS. 3 and 4 are, respectively, a perspective view and a sectional view for illustrating the internal structure of the valve device 1 according to the embodiment and the internal structure of the multi-layer substrate 2 to which the valve device 1 is secured. FIGS. 3 and 4 are sectional views taken along an alternate long and short dash line in FIG. 2.

As shown in FIGS. 3 and 4, the motor 5 is secured to the housing 4 while a driving shaft 55 is accommodated in the housing 4. The speed reduction mechanism 8 that reduces the speed of rotation of the driving shaft 55 and the converting mechanism 9 that converts rotational motion, whose speed is reduced by the speed reduction mechanism 8, into linear motion are disposed in the housing 4. The speed reduction mechanism 8 includes a planetary gear mechanism including a rotary member 82 and a rotary member 81. The rotary member 81 is connected to the driving shaft 55. The rotary member 82 moves in response to the rotary member 81 through a planetary gear (not shown). The converting mechanism 9 has a thread groove (not shown), a screw thread, and a lead screw 91. The thread groove is formed in an inner wall of the rotary member 82. The screw thread engages the thread groove. The lead screw 91 reciprocates vertically in FIGS. 3 and 4 in accordance with the rotation of the rotary member 82.

The lead screw 91 reciprocates vertically between the housing 4 and the base 3 in accordance with the driving of the motor 5. The diaphragm 10, serving as a valve, is mounted to a shaft 91a provided at a lower end portion of the lead screw 91. The diaphragm 10 is formed of a nonmagnetic and resilient material, and generally has a circular shape in top view. As described below, the diaphragm 10 has a protrusion 10a protruding downward in FIGS. 3 and 4 in a vicinity of the center of the diaphragm 10, and opens and closes the flow paths, formed in the layers of the multi-layer substrate 2, as the lead screw 91 reciprocates.

Here, when the motor 5 is a stepping motor, not only can the flow paths be simply opened and closed, but also the position of the shaft 91a provided at the lower end portion of the lead screw 91 is also determined in accordance with the number of input steps. Therefore, multiple gradient control of the flow amount can be performed. When a flow-amount sensor (not shown) is disposed at a downstream side of the valve device 1, on the basis of the flow amount measured with the flow-amount sensor, the lead screw 91 is moved upward and downwards to quickly and precisely vary the flow amount of a fluid flowing from an inflow path 25 (described later) to an outflow path 27 (described later). This makes it possible to perform a proper flow amount control.

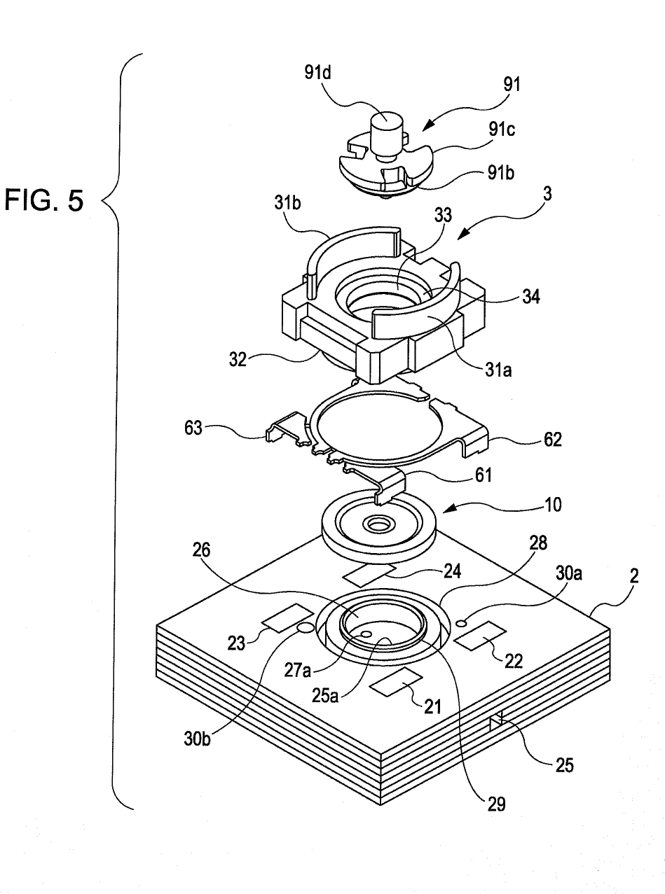

The inflow path 25 is formed in the layers of the multi-layer substrate 2 so as to extend horizontally towards the inner side of the multi-layer substrate 2 from a right end surface (in FIGS. 3 and 4) of the multi-layer substrate 2. The inflow path 25 is bent upward in the vicinity of the center of the multi-layer substrate 2, and has an inflow hole 25a that is connected to a valve chamber 26. The valve chamber 26 has a circular recess provided at the top surface of the multi-layer substrate 2 (refer to FIG. 5). The outflow path 27 is formed in the layers of the multi-layer substrate 2 so as to extend horizontally from the valve chamber 26 to a left end surface (in FIGS. 3 and 4) of the multi-layer substrate 2. The outflow path 27 is bent upward in the vicinity of the center of the multi-layer substrate 2, and has an outflow hole 27a which is connected to the valve chamber 26. The inflow path 25, the valve chamber 26, and the outflow path 27 are flow paths of the multi-layer substrate 2.

The circular annular groove 28 is formed in the top surface of the multi-layer substrate 2, and is formed at a location that is separated from the valve chamber 26 by a certain distance. As described in detail later, the circular annular protrusion 32, formed at the lower surface of the base 3, is mounted to the groove 28. By mounting the protrusion 32 to the groove 28 in this way, the valve device 1 is positioned with respect to the multi-layer substrate 2.

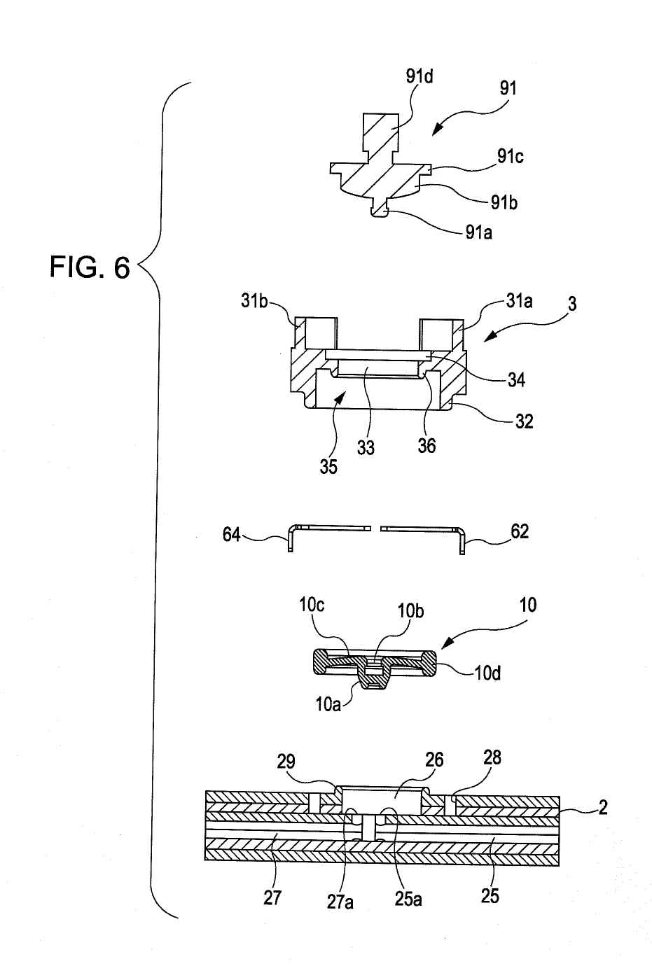

Here, the state of the diaphragm 10 when the valve device 1 according to the embodiment is secured to the multi-layer substrate 2 will be described. FIGS. 5 and 6 illustrate the state of the diaphragm 10 when the valve device 1 according to the embodiment is secured to the multi-layer substrate 2. FIG. 5 is an exploded perspective view of the multi-layer substrate 2 and structural parts in the vicinity of the diaphragm 10 of the valve device 1 according to the embodiment. FIG. 6 is a sectional view in which the multi-layer substrate 2 and the structural parts of the valve device 1 shown in FIG. 5 are cut along the flow paths of the multi-layer substrate 2. In FIGS. 5 and 6, the base 3, the input terminals 61 to 64, and the lead screw 91 are only shown as the structural parts in the vicinity of the diaphragm 10, so that the other structural parts are not shown.

As shown in FIGS. 5 and 6, the lead screw 91 has a body 91b, three protrusions 91c, and a connection shaft 91d. The body 91b has a shaft 91a at a lower end portion thereof. The protrusions 91c are formed so as to protrude sideways from a top end portion of the body 91b. The connection shaft 91d is formed at the center of the top surface of the body 91b. In the lead screw 91, a screw thread is formed at the side surface of the connection shaft 91d, and is connected to the rotary member 82 of the speed reduction mechanism 8.

A circular open portion 33 into which the body 91b of the lead screw 91 can be inserted is formed in the center of the base 3. A step 34 is formed along the open portion 33. The step 34 is formed with a dimension that allows the protrusions 91c of the lead screw 91 to be inserted, and has a structure that allows the protrusions 91c to advance as the lead screw 91 moves upward and downward. A space 35 (not shown in FIG. 5; refer to FIG. 6) that accommodates the diaphragm 10 is provided below the open portion 33. A circular annular protrusion 36, formed so as to protrude downward in the vicinity of the open portion 33, is formed at the upper side of the space 35.

The diaphragm 10 has a thin-walled deformation portion 10c and a thick-walled portion 10d. The thin-walled deformation portion 10c has a protrusion 10a, provided at the lower side of the diaphragm 10, and an engaging hole 10b, which is provided at the upper side of the diaphragm 10 and which engages the shaft 91a of the lead screw 91. The thick-walled portion 10d is provided at the peripheral edge of the deformation portion 10c, and functions as a movement restricting portion. The diameter of the outer periphery of the thick-walled portion 10d is slightly longer than the inside diameter of the inner peripheral side of the space 35 in the base 3. The diameter of the inner periphery of the thick-walled portion 10d is slightly shorter than the diameter of the outer periphery of the protrusion 36. As described later, when the diaphragm 10 is accommodated in the space 35, the thick-walled portion 10d is press-fitted between the inner peripheral side of the space 35 and the protrusion 36.

As mentioned above, the multi-layer substrate 2 is provided with the circular valve chamber 26 where the inflow hole 25a and the outflow hole 27a are formed in the bottom surface of the multi-layer substrate 2. The circular annular protrusion 29, formed so as to protrude upward, is provided along the circumference of the valve chamber 26. The diameter of the protrusion 29 is equal to that of the protrusion 36 provided in the space 35 of the base 3. The circular annular groove 28 is provided along the circumference of the protrusion 29 and at the inner side of the connection portions 21 to 24. The diameter of the groove 28 is substantially equal to that of the protrusion 32 provided at the base 3, and the groove 28 can accommodate the protrusion 32. The groove 28 functions as a recess formed in the multi-layer substrate 2, and the protrusion 32 functions as a protruding portion of the base 3.

The holes 30a and 30b (not shown in FIG. 6) are provided at the outer side of the groove 28 and in the vicinity of the connection portions 22 and 23. The holes 30a and 30b are used for inserting therein the shafts (not shown) provided at the lower surface of the base 3, and are provided for positioning the base 3. The hole 30a is smaller than the hole 30b. The shafts of the base 3 are formed with thicknesses corresponding to the sizes of the holes 30a and 30b. This can prevent the base 3 from being mounted in a wrong orientation, so that the valve device 1 can be positioned in a proper orientation.

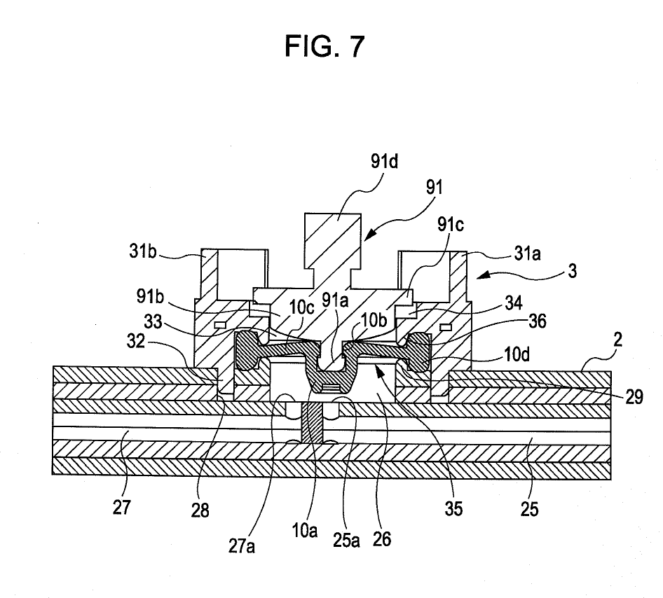

FIG. 7 is a sectional view showing a state of structural parts in the vicinity of the diaphragm 10 when the valve device 1 according to the embodiment is secured to the multi-layer substrate 2. In FIG. 7, for convenience of explanation, the multi-layer substrate 2 and the structural parts shown in FIGS. 5 and 6 are only shown, so that the other structural parts are not shown. In FIG. 7, the flow paths are shown as being opened using the protrusion 10a of the diaphragm 10. In this case, as shown in FIG. 7, the body 91b of the lead screw 91 is disposed at a position where it is retreated slightly upward from the open portion 33. The shaft 91a of the lead screw 91 is disposed at a location where it protrudes towards the valve chamber 26 through the open portion 33.

In this case, the diaphragm 10 is press-fitted in the space 35 of the base 3, that is, the thick-walled portion 10d is interposed between the inner peripheral side of the space 35 and an outer peripheral portion of the protrusion 36. In addition, the shaft 91a of the lead screw 91 engages the engaging hole 10b of the diaphragm 10 held by the base 3 in this way. By engaging the shaft 91a with the engaging hole 10b in this way, the diaphragm 10 can reciprocate upward and downward together with the lead screw 91.

The base 3 holding the diaphragm 10 in this way is mounted to the multi-layer substrate 2. In this case, the base 3 is mounted so that the protrusion 32 is inserted into the groove 28 of the multi-layer substrate 2. When the base 3 is mounted to the multi-layer substrate 2 in this way, the diaphragm 10 is interposed between the protrusion 36 of the base 3 and the protrusion 29 of the multi-layer substrate 2. The protrusion 36 of the base 3 and the protrusion 29 of the multi-layer substrate 2 sandwich the diaphragm 10 slightly inwardly of the thick-walled portion 10d. Therefore, it is possible to reliably prevent the diaphragm 10 from becoming displaced or from falling from its predetermined position (shown in FIG. 7).

In the state in which the base 3 is mounted to the multi-layer substrate 2 in this way, the lower surface of the protrusion 10a of the diaphragm 10 is disposed at a location opposing the inflow hole 25a of the inflow path 25 and separated by a certain distance from the inflow hole 25a. The lower surface of the protrusion 10a is provided with a recess that opens downward so as to reliably close the inflow hole 25a. By forming the recess, the inflow hole 25a can be covered, so that the inflow hole 25a can be reliably stopped.

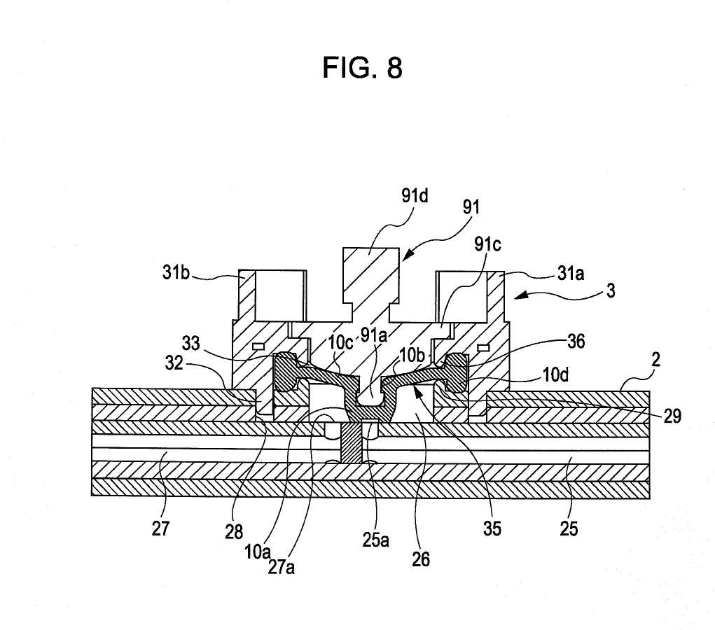

Next, the operations performed when opening and closing the flow paths of the multi-layer substrate 2 with the valve device 1 according to the embodiment will be described with reference to FIGS. 7 and 8. FIG. 8 shows a state in which the flow paths formed in the multi-layer substrate 2 are closed by the valve device 1 according to the embodiment. In FIG. 8, for convenience of explanation, the multi-layer substrate 2 and the structural parts shown in FIG. 7 are only shown, so that the other structural parts are not shown.

When the flow paths formed in the multi-layer substrate 2 are open, as shown in FIG. 7, the motor 5 causes the lead screw 91 to retreat to an upper predetermined location. In this case, the lower surface of the protrusion 10a of the diaphragm 10 is separated from the inflow hole 25a. This causes the inflow path 25, the valve chamber 26, and the outflow path 27 to be connected to each other, so that fluid can flow in the flow paths.

In contrast, when the flow paths are closed from the state shown in FIG. 7, the motor 5 causes the lead screw 91 to move to a lower predetermined location. This causes the deformation portion 10c of the diaphragm 10 to deform downward in accordance with the downward movement of the lead screw 91, so that the lower surface of the protrusion 10a is lowered to where it stops the inflow hole 25a. This causes blocking between the inflow path 25 and the valve chamber 26, thereby limiting the flow of fluid in the flow paths.

When the flow paths are further opened from the state shown in FIG. 8, the motor 5 causes the lead screw 91 to move upward from the predetermined position shown in FIG. 7. This causes the lower surface of the protrusion 10a of the diaphragm 10 to separate from the inflow hole 25a again, so that the inflow path 25, the valve chamber 26, and the outflow path 27 are connected to each other. This makes it possible for fluid to flow through the liquid paths.

According to the valve device 1 of the embodiment, when the valve device 1 is secured to the multi-layer substrate 2, the diaphragm 10 is held by the base 3 between the base 3 and the multi-layer substrate 2. Therefore, the diaphragm 10 can be properly positioned at a predetermined location of the multi-layer substrate 2. Consequently, it is possible to prevent displacement and falling of the diaphragm 10, so that the flow paths formed in the layers of the multi-layer substrate 2 can be properly opened and closed. As a result, since it is no longer necessary to form flow paths in the valve device 1, the structure of the valve device 1 is simplified. Thus, it is possible to reduce the size of the valve device 1 and manufacturing costs thereof.

In particular, in the valve device 1 according to the embodiment, the input terminals 61 to 64, which are electrically joined to an electrical wire formed at the multi-layer substrate 2, are provided near the securing surface of the valve device 1 where it is secured to the multi-layer substrate 2. Therefore, the input terminals 61 to 64 can be easily electrically joined to the electrical wire by an operation step that is performed when securing the valve device 1 to the multi-layer substrate 2. Consequently, it is possible to provide the valve device 1 that has work efficiency when electrically joining the valve device 1 to the multi-layer substrate 2.

In the valve device 1 according to the embodiment, the base 3 is provided with the protrusion 36 at a location corresponding to the location of the protrusion 29 of the substrate 2, with the diaphragm 10 being disposed between the protrusions 36 and 29. This makes it possible to interpose the diaphragm 10 between the protrusion 29 of the substrate 2 and the protrusion 36 of the base 3 provided at the location that is in correspondence with the location of the protrusion 29. Therefore, it is possible to more reliably position the diaphragm 10 at a predetermined location of the substrate 2.

In particular, in the valve device 1 according to the embodiment, the protrusion 29 of the multi-layer substrate 2 and the protrusion 36 of the base 3 are annular (circular annular in the embodiment), and the thick-walled portion 10d, serving as a movement restricting portion that restricts the movement of the diaphragm 10 and that is disposed outwardly of the protrusions 29 and 36, is provided at the diaphragm 10. This makes it possible to restrict the movement of the diaphragm 10 by bringing the outer portion of the protrusion 29 of the multi-layer substrate 2 and the outer portion of the protrusion 36 of the base 3 into contact with the thick-walled portion 10d of the diaphragm 10. Therefore, it is possible to reliably prevent the diaphragm 10 from becoming displaced or from falling when driving the valve device 1.

Further, in the valve device 1 according to the embodiment, the valve device 1 is secured to the multi-layer substrate 2 by making use of the protrusion 32 of the base 3 and the groove 28 formed in the multi-layer substrate 2. This makes it possible to reliably secure the valve device 1 to a predetermined location on the multi-layer substrate 2. As a result, the diaphragm 10 held by the base 3 can be positioned at a predetermined location of the multi-layer substrate 10.

In particular, in the valve device 1 according to the embodiment, the groove 28, formed in the multi-layer substrate 2, and the protrusion 32, provided at the base 3, are annular (circular annular in the embodiment). This makes it possible to mount the protrusion 32 of the base 3 to the groove 28 of the multi-layer substrate 2, so that the valve device 1 can be secured to the multi-layer substrate 2 so as not to move. Therefore, displacement or falling of the diaphragm 10 caused by vibration of the valve device 1, itself, when the valve device 1 (motor 5) is driven can be reliably prevented.

The present invention is not limited to the embodiment, so that various modifications can be made to carry out the invention. For example, the sizes and shapes are not limited to those shown in the attached drawings in the embodiment. Modifications can be made as appropriate within the scope that allows the advantages of the present invention to be provided. In addition, it is possible to make modifications as appropriate without departing from the scope of the object of the present invention, to carry out the present invention.

For example, in the embodiment, the valve device 1 is described as including the motor 5, serving as driving means for driving the diaphragm 10 of the valve device 1, and the input terminals 51 to 54 for inputting a motor drive signal transmitted towards the motor 5. However, the structure of the driving means for driving the diaphragm 10 is not limited thereto, so that it can be modified as appropriate. For example, other types of actuators may be used in addition to a stepping motor. When an actuator other than a stepping motor is used, if necessary, a sensor that inputs an external signal to the actuator and that monitors the position of the actuator, or a terminal (input-output terminal) for outputting the signal from the sensor to the outside may be provided.

What is claimed is:

1. A valve device secured to a multi-layer substrate provided with an electrical wire and a flow path for a fluid, the valve device comprising:
a valve disposed at a location allowing the flow path to be opened and closed;
an actuator that causes the flow path to be opened and closed by reciprocating the valve; and
an enclosure that holds the valve while the valve is interposed between the enclosure and the multi-layer substrate when securing the valve device to the multi-layer substrate,
wherein a terminal electrically joined to the electrical wire is provided near a securing surface where the valve device is secured to the multi-layer substrate.

2. The valve device according to claim 1, wherein the enclosure is provided with a protrusion at a location allowing the valve to be interposed between the enclosure and the multi-layer substrate.

3. The valve device according to claim 2, wherein the protrusion is annular, and the valve is provided with a movement restricting portion disposed outwardly of the annular protrusion and restricting movement of the valve.

4. The valve device according to claim 1, wherein the enclosure is provided with a protruding portion for insertion into the multi-layer substrate.

5. The valve device according to claim 4, wherein the protruding portion of the enclosure is annular.

6. The valve device according to claim 1, wherein the terminal of the valve device is soldered to the electrical wire of the multi-layer substrate.

7. The valve device according to claim 1, wherein the enclosure is provided with a plurality of shafts for positioning a location where the enclosure is secured to the multi-layer substrate.

8. The valve device according to claim 1 wherein the multi-layer substrate is provided with a protrusion at a location corresponding to a location of the enclosure, the protrusion being used for interposing the valve between the multi-layer substrate and the valve device.

9. The valve device according to claim 4 wherein the multi-layer substrate is provided with a recess at a location corresponding to a location of the protruding portion of the enclosure, the recess being used for inserting therein the valve device.

10. The valve device according to claim 7 wherein the multi-layer substrate is provided with a plurality of positioning holes for inserting therein the shafts of the enclosure.
